(19) United States
(12) Patent Application Publication
(10) Pub. No.: US 2002/0078339 A1
(43) Pub. Date: Jun. 20, 2002

(54) Booting system and booting method for an assistant operation system

(76) Inventors: Shen Hung-Ju, Ying-Ko Chen (TW); Yu-Chuan Lin, Chu-Pei (TW)

Correspondence Address: J.C. Patents, Inc., Suite 114, 1340 Reynolds Ave., Irvine, CA, 92614, US

(21) Appl. No.: 09/761,942

(22) Filed: Jan. 17, 2001

(30) Foreign Application Priority Data
Dec. 15, 2000 (TW) 89126853

(51) Int. Cl. G06F 15/177; G06F 9/00

(52) U.S. Cl. 713/2

(57) ABSTRACT

A booting system and a method of booting an assistant operating system. The booting system includes a host computer and a system boot card. The host computer further includes a central processor, a memory unit and an input/output interface. The main operating system of the host computer is controlled by the central processor. The system boot card includes a data storage region and an interface control module. The system boot card communicates with the input/output interface of host computer via the interface control module. After the transmission of assistant operating system to the host computer, the central processor is able to utilize the functions provided by the assistant operating system to enhance performance.

### CROSS-REFERENCE TO RELATED APPLICATION

This application claims the priority benefit of Taiwan application Ser. no. 89126853, filed Dec. 15, 2000.

### BACKGROUND OF THE INVENTION

1. Field of Invention

The present invention relates to an assistant operating system. More particularly, the present invention relates to a booting system and a booting method for an assistant operating system.

2. Description of Related Art

Following the rapid growth of computer hardware, driver programs for booting various types of hardware must also be provided and installed inside the computer. Due to the need to control an increasing number of hardware products, the required operating system may grow in proportionately. Accompanying the rapid growth in operating system, storage space for holding data is going to increase and the execution of an instruction is going to take longer.

### SUMMARY OF THE INVENTION

Accordingly, one object of the present invention is to provide a booting system and a booting method for an assistant operating system. The concept is to use a detached operating system. Thus, the amount of storage space in the host system for holding the operating system is reduced and the time for the host system in normal operation to initiate the operating system is shortened.

To achieve these and other advantages and in accordance with the purpose of the invention, as embodied and broadly described herein, the invention provides a booting system for an assistant operating system. The booting system includes a host computer and a system boot card. The host computer includes a central processor, a memory unit and an input/output interface. The main operating system of the host computer is controlled by the central processor. The system boot card includes a data storage region and an interface control module. The system boot card communicates with the input/output interface of host computer via the interface control module. An assistant operating system is stored inside the data storage region of the data boot card. After the transmission of assistant operating system to the host computer, the central processor is able to utilize the functions provided by the assistant operating system to enhance performance.

In addition, the data storage region within the system boot card may actually includes a system storage region and a parameter storage region. The system storage region is a place for storing the assistant operating system while the parameter storage region is a place for holding the parameters necessary for executing the assistance operating system.

This invention also provides a booting method for an assistant operating system. The booting method is suitable for the input of an assistant operating system via a system boot card. First, a main operating system is initiated in a host computer. The assistant operation system is input into the host computer via the system boot card. The downloaded assistant operating system is executed in tandem with the main operation system to enhance performance. The assistant operating system may support functions not provided by the main operating system or may increase the operating efficiency of the main operating system.

In addition, before executing the assistant operation system brought in via the system boot card, the assistant operating system stored inside the system boot card may also be re-programmed according to the demands of the main operating system.

In brief, one major aspect of this invention is the detachment of the assistant operating system from the main operating system. The most commonly used portion of an operating system is separated from extra software for supporting additional hardware. Hence, size, complexity and downloading time of the main operating system can be reduced considerably. The re-programmable or multiple card insertion type of system boot card is able to provide a variety of different functions in the assistant operating system on demand.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings, FIG. 1 is a block diagram showing a booting system for an assistant operating system according to one preferred embodiment of this invention; and

FIG. 2 is a flow chart showing a method of operating the booting system according to one preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

FIG. 1 is a block diagram showing a booting system for an assistant operating system according to one preferred embodiment of this invention. The booting system 100 for the assistant operating system includes a host computer 110 and a system boot card 130. The host computer 110 is electrically connected to the system boot card 130 via a bus 150 and hence the host computer 110 and the system boot card 130 can communicated with each other. The host computer 110 further includes an input/output interface 112, a central processor 114, a memory unit 116 and an extension input/output (I/O) interface 118. In addition, the extension I/O interface 118 is coupled to another extension I/O interface 120. The system boot card 130 includes an interface control module 132 and a data storage region 140. In this embodiment, the data storage region can be sub-divided into a system storage region 142 and a parameter storage region 144. The system storage region 142 inside the system boot card 130 is a place for storing the assistant operating system. The parameter storage region 144 is a place for holding necessary parameters for executing the assistant operating system. The content inside the data storage region 142 and the parameter storage region 144 can be repeatedly programmed. According to the demands by a user or the main operating system inside the host computer, the assistant operating system and related parameters may be modified.

By executing the main operating system, the central processor 114 of the host computer 110 is able to control the input/output interface 112. In other words, after the main operating system is initialized, the host computer 110 can obtain data from the system boot card 130 via the input/output interface 112. When the host computer 110 needs to access data from the system boot card 130, the input/output interface 112 and the interface control module 132 must first established a communication protocol. Thereafter, the assistant operating system stored inside the data storage region 140 is transferred via the interface control module 132, the bus 150 and the input/output interface 112 into the memory unit 116. According to this embodiment, the host computer 110 can control the extension I/O device 120 via the extension I/O interface 118 when the central processor 114 starts to execute the instructions in the assistant operating system.

Note that the aforementioned description is used as an illustration only. The illustration should not be construed as a limitation of this invention. For example, the main operating system may be used to support the extension I/O interface 118 while the assistant operating system may be used to expand the range of support or increase performance efficiency. In addition, a multiple of system boot cards 130 instead of a single one may be coupled to the bus 150.

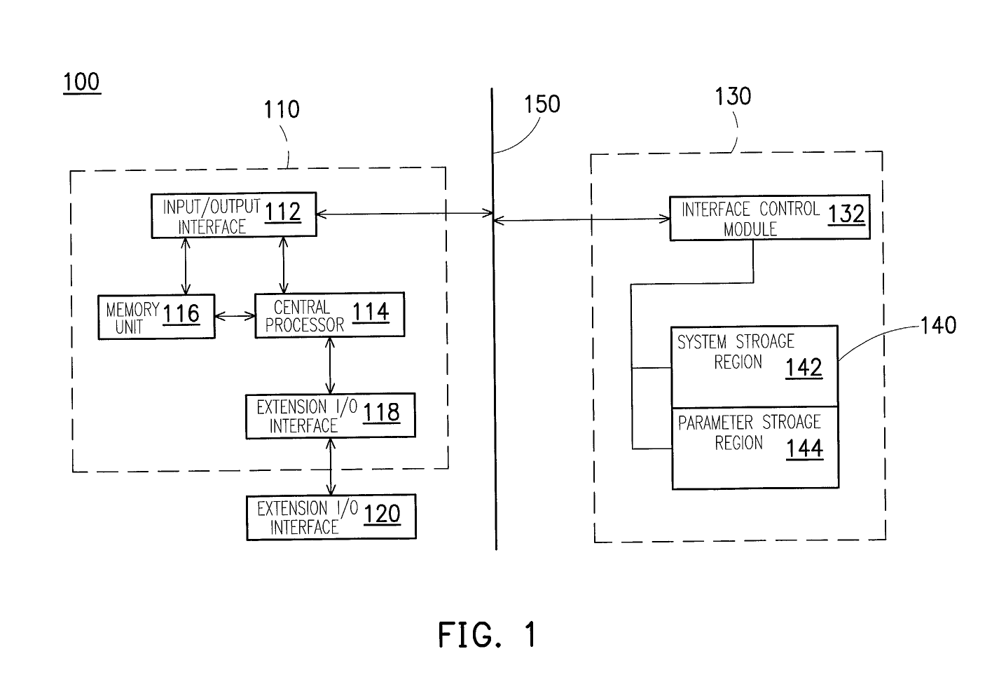

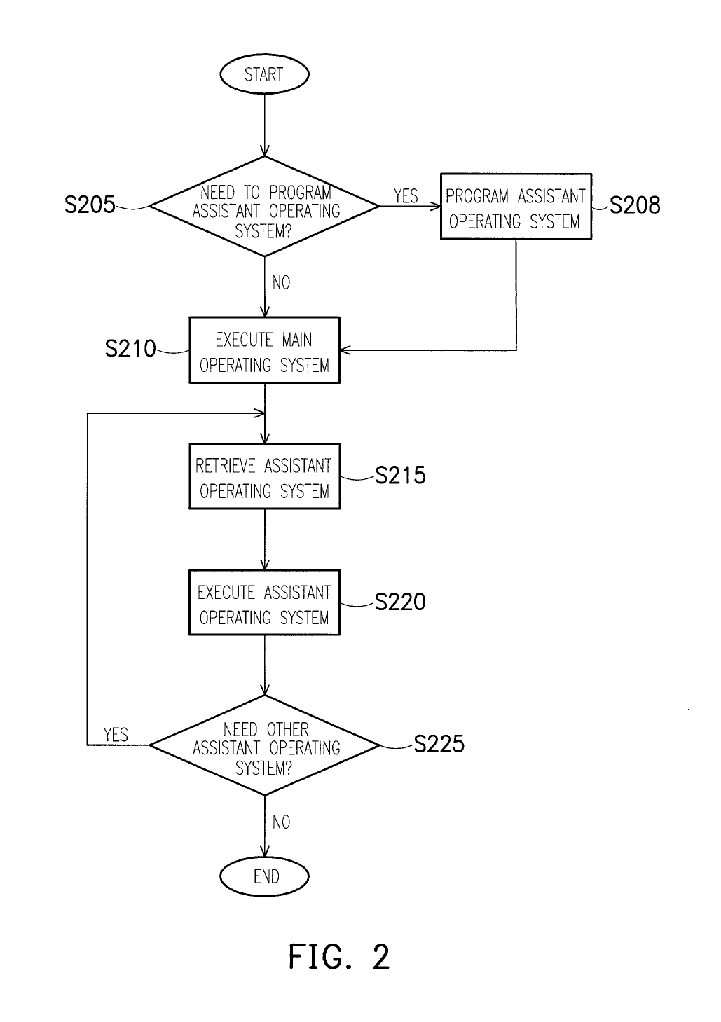

FIG. 2 is a flow chart showing the steps for operating the booting system according to one preferred embodiment of this invention. In step S205, the main operating system determines if the assistant operating system (or other parameters) within the system boot card needs to be modified by programming. When some of the content needs to be modified, the assistant operating system (or other parameters) is changed by programming in step S210. On the other hand, if no change in the content is required, control jumps directly to step S210. In step S210, the host computer executes the software in the main operating system, and hence the host computer may be able to communicate with the system boot card. In step S215, the assistant operating system is retrieved from the system boot card and then the programs in the assistant operating system is executed. In the subsequent step, the main operating system determines if any other assistant operating system is required in step S225. If no other program from the assistant operating system is further required, this portion of the control flow terminates. On the contrary, if other programs in the assistant operating system are required, control is returned to step S215.

Note that the actual steps in using the assistant operating system need not be exactly as in the aforementioned description. For example, the decision to program the assistant operation system (step S205) and the actual programming (step S208) can be separated out from other steps. Hence, one or more system boot cards can be programmed repeatedly or a multiple of system boot cards can be programmed once to obtain an identical result.

In summary, one major advantage of this invention is the reduction of size, complexity and downloading time of the main operating system. Moreover, the re-programmable or multiple card insertion type of system boot card is able to provide a variety of different functions in the assistant operating system on demand.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A system for booting an assistant operating system, comprising:
a host computer that includes a central processor, a memory unit and an input/output interface, wherein the host computer is able to execute a main operating system; and
a system boot card that includes a data storage region and an interface control module, wherein the system boot card and the input/output interface can communicate with each other via the interface control module, and the programs in the assistant operating system is stored in the data storage region so that capability of the host computer can be enhanced after the assistant operating system is downloaded into the host computer and executed by the central processor.

2. The system of claim 1, wherein the program data within the data storage region of the system boot card can be modified repeatedly.

3. The system of claim 1, wherein the input/output interface can coupled with a plurality of system boot cards.

4. The system of claim 1, wherein the data storage region further includes:
a system storage region for holding the assistant operating system; and
a parameter storage region for holding the parameters necessary for executing the assistant operating system.

5. A method of booting an assistant operating system, comprising the steps of:
executing a main operating system;
retrieving the assistant operating system from a system boot card; and
executing the assistant operating system to boost the performance of the main operating system.

6. The method of claim 5, wherein the assistant operating system supports functions not supplied by the main operating system.

7. The method of claim 5, wherein the assistant operating system enhances the functions of the main operating system.

8. The method of claim 5, wherein before the step of executing the assistant operating system retrieved from the system boot card, further includes programming the assistant operating system according to the requirements of the main operating system.
